(19) United States
(12) Patent Application Publication
(10) Pub. No.: US 2012/0312022 A1
(43) Pub. Date: Dec. 13, 2012

(54) COALESCING FILTER

(75) Inventors: Joseph K-W Lam, Bristol (GB); Franklin Tichborne, Bristol (GB); David Parmenter, Uckfield (GB); Simon Masters, Bristol (GB)

(73) Assignee: AIRBUS OPERATIONS LIMITED, Bristol (GB)

(21) Appl. No.: 13/578,648

(22) PCT Filed: Mar. 17, 2011
(86) PCT No.: PCT/GB11/50534

§ 371 Date: Aug. 13, 2012

(30) Foreign Application Priority Data
Mar. 23, 2010 (GB) 1004836.1

(51) Int. Cl. F02M 37/00; F02C 7/22; B01D 37/00

(52) U.S. Cl. 60/734; 210/805; 210/790; 210/791

(57) ABSTRACT

A fuel system comprising a liquid fuel tank, an engine, and a coalescing filter adapted to separate water from fuel, the filter having an inlet fluidically connected to the fuel tank, a first outlet fluidically connected to a fuel feed system for the engine, and a second outlet fluidically connected to the fuel tank, wherein the coalescing filter is adapted to discharge fuel filtrate from the second outlet and filtrand from the first outlet. Also, a method of removing water or ice from a fuel tank, the method comprising directing a flow of fuel from a fuel tank to a coalescing filter adapted to separate water from fuel, discharging filtrand from a first outlet of the coalescing filter to a fuel feed system for consumption by an engine, and discharging fuel filtrate from a second outlet of the coalescing filter and returning the fuel filtrate to the fuel tank.

### FIELD OF THE INVENTION

The present invention relates to a fuel system including a coalescing filter for separating water from fuel. Also, a method of removing water or ice from a fuel tank.

### BACKGROUND OF THE INVENTION

Water is an unavoidable contaminant in fuel. Water can affect components in fuel systems and lead to operational delays and increased maintenance activities. In addition, the propensity for microbiological contamination is directly proportional to the presence of water and the temperature within fuel tanks.

Although water may affect fuel systems of land or water based vehicles, water is a particular problem in aircraft fuel systems. Water may enter aircraft fuel tanks from fuel loaded into the aircraft fuel tanks during refuel (dissolved water) and from air entering the aircraft fuel tanks via its vent system. A vent system to ambient air is normally required to normalise the pressure within the fuel tanks during climb and descent of the aircraft.

Since the solubility of water in fuel decreases with decreasing temperature, during aircraft cruise water dissolution from fuel occurs as the fuel temperature decreases. It forms small droplets of the order of microns. The droplets remain suspended in the fuel and create an almost homogeneous mist or fog-like phenomenon in fuel. The water droplets have a density (around 1000 kg/m³) similar to that of aviation fuel (around 800 kg/m³). The water droplet size and the relative density of the water droplets and the surrounding fuel are key parameters determining the settling rate of the droplets (Stokes' Law). The settling velocity is proportional to the square of the droplet radius. With the droplet size of the order of microns, it takes a long time for the droplets to settle out to the tank bottom. The density difference is small, although significant, but in this case the primary factor determining the slow settling rate of the droplets is their size. The fuel with suspended water droplets is fed to the engine where it is “burnt off” with the fuel. However, the low concentration of water in suspension means that the rate of water removal from the fuel system is slow.

As the temperature within the fuel tank decreases during the cruise phase of an aircraft flight, the suspended water droplets can turn to ice forming “snow”. The snow takes even longer to sink to the bottom of the fuel tank as the density of the ice (around 900 kg/m³) is even closer to that of the fuel than the water droplets.

In addition, the mist or fog-like phenomenon in fuel tends to be cleared off when a sufficient natural convection current is established in the fuel tank. Drier (unsaturated) fuel carried by the natural convection current from colder tank structures and surfaces re-dissolves the suspended water droplets. The natural convection current carries the saturated fuel to bring it in contact with cold tank surfaces where water dissolution from the fuel causes condensation on cold surfaces. The condensation tends to run down the wall of the fuel tank and collect in pools at the bottom of the tank. Water from these pools can be drained off when the aircraft is on the ground but this is time consuming and costly, leading to a loss of operational efficiency.

U.S. Pat. No. 4,081,373 describes a system in which a cyclonic separator and a water coalescer are connected within a fuel system. Fuel from a fuel tank is fed into the cyclonic separator, which separates relatively pure fuel from a fuel-impurity concentrate. The fuel-impurity concentrate is then fed to the water coalescer, which causes water droplets in the fuel impurity concentrate to agglomerate into larger droplets, which settle out under gravity and are collected in a sump. The combined cyclonic separator and water coalescer returns “purified” fuel to the fuel tank, and water, along with some fuel, is discharged from the sump to an auxiliary separator. The auxiliary separator returns further “purified” fuel to the fuel tank and a water-solid (impurity) sludge is separated out and periodically drained off The impurity sludge is exhausted either to the atmosphere or to a collection vessel. Where a collection vessel is used this will still need to be drained when the aircraft is on the ground. In the case of exhausting to the atmosphere, a suitable exhaust system will be required, which adds weight, maintenance costs etc. to the fuel system and could lead to icing problems at the outlet. Furthermore, the coalescing filter requires periodic replacement, which adds to maintenance costs.

### SUMMARY OF THE INVENTION

A first aspect of the invention provides a fuel system comprising a liquid fuel tank, an engine, and a coalescing filter adapted to separate water from fuel, the filter having an inlet fluidically connected to the fuel tank, a first outlet fluidically connected to a fuel feed system for the engine, and a second outlet fluidically connected to the fuel tank, wherein the coalescing filter is adapted to discharge fuel filtrate from the second outlet and filtrand from the first outlet.

A further aspect of the invention provides a method of removing water or ice from a fuel tank, the method comprising directing a flow of fuel from a fuel tank to a coalescing filter adapted to separate water from fuel, discharging filtrand from a first outlet of the coalescing filter to a fuel feed system for consumption by an engine, and discharging fuel filtrate from a second outlet of the coalescing filter and returning the fuel filtrate to the fuel tank.

In operation, water or ice naturally occurring in the fuel will be separated or at least concentrated by the coalescing filter to form a water rich filtrand which can be fed to the engine to be “burnt off” with the fuel. The purified fuel filtrate exiting from the second outlet of the coalescing filter is fed back into the fuel tank. The concentration of water in the water rich filtrand is preferably several orders of magnitude higher than that of the fuel in the tank and so water is removed more quickly from the fuel tank by the fuel system and method of the present invention. By removing water from the tank, rather than merely dispersing condensation back into the tank, the concentration of water in the tank is kept low and problems associated with water condensation within the tank are prevented, even at low temperatures.

The fuel system may be employed in a vehicle. In a preferred embodiment, the vehicle is an aircraft. It is preferable to remove the water when the water is suspended in the fuel. Once condensation occurs and water droplets have coalesced into larger droplets, pools and films, water is not readily re-dissolved in the fuel, even when the fuel temperature is raised increasing the solubility of water in fuel. Further devices, such as water scavenging lines, may be required to collect water that condenses and pools within the tank. Since the concentration of water in the water rich filtrand is initially much higher than that in the tank, the rate of removal of the water may be initially high and decreases as the water content of the fuel in the tank decreases. Removing water quickly at the start of operation of the coalescing filter minimises water accumulation in the tank, before the critical icing temperatures are reached. Accordingly, the coalescing filter is preferably operated during cruise. However, it may be operated during any phase of the flight (taxi, take-off, cruise or land). For example, water may be induced from a fuel tank sump into an induction line by a jet pump during the early phase of the flight (taxi and take-off) and discharged with motive flow to the coalescing filter.

The inlet of the coalescing filter is preferably connected to a fuel line adapted to entrain fuel containing some water or ice from a region of the fuel tank in which water or ice, preferably still in suspension, tends to collect. The fuel line is preferably connected to a fuel pump or forms part of a pressurised system for delivering fuel to the coalescing filter. The pump may be a jet pump or the like.

The engine fuel feed system is preferably adapted to entrain fuel from the fuel tank. To reduce the concentration of water being fed to the engine, the water rich filtrand from the coalescing filter is mixed with fuel from the tank before being fed to the engine. The concentration of water fed to the engine may be controlled so it does not exceed the recommended limit set by the engine manufacturers.

The coalescing filter may include one or more filter cartridges disposed inside a filter chamber.

The coalescing filter may be adapted to perform a self-purging operation for the filter cartridge. This reduces, or eliminates, maintenance activities for the filter.

The coalescing filter may include a valve arrangement for reversing the direction of flow of the fuel filtrate through the filter cartridge during the purging operation. Alternatively, the coalescing filter may include a reciprocating plunger for mechanically dislodging filtrand from the filter cartridge during the purging operation.

The coalescing filter may include a plurality of the filter cartridges disposed inside the filter chamber, and may be adapted to perform the self-purging operation by purging one or more of the plurality of filter cartridges, whilst at least one of the other filter cartridges remains operational. Performing the purging operation whilst the filter is operational has several advantages. Since there are a plurality of filter cartridges, the filter may be operated continuously, even during the purging operation. The filtrand released from the cartridge during the purging operation does not affect the operation of the remaining filter cartridge(s). The filter cartridge(s) can be kept substantially free from debris and therefore efficient operation of the filter device can be ensured.

Preferably, the coalescing filter is adapted to perform the self-purging operation by purging each filter cartridge in turn, whilst the other filter cartridges remain operational. Each filter cartridge is therefore regularly purged such that efficient operation of the filter device can be ensured. The order in which the cartridges are purged may be dependent on their arrangement within the filter chamber. In a preferred embodiment, the cartridges are arranged symmetrically around a longitudinal axis in a substantially cylindrical filter chamber. The cartridges may be purged cyclically in turn, proceeding in a clockwise or anti-clockwise direction about the longitudinal axis. This beneficially provides simplified control of the purging operations. However, the cartridges may be purged in any order.

The coalescing filter preferably includes a sump disposed beneath the filter chamber for collecting the filtrand. The sump may be substantially funnel shaped such that the filtrand flows to the first outlet, which may be centrally located in the sump. The sump preferably extends beneath each of the filter cartridges so as to collect the filtrand falling under gravity from the cartridges into the sump during the filtering operation and during the purging operation. The sump may include a heating element to prevent ice formation when the filter device is exposed to temperatures near or below 0 degrees Celsius. The heating element may particularly be required when the filter is installed in an aircraft fuel system, which can regularly reach sub-zero temperatures. If ice were to form in the sump or at the first outlet, it could block the filtrand outflow from the filter.

The fuel system may further comprise a water scavenging system for scavenging water from the fuel tank, wherein a water drain outlet of the water scavenging system is connected to the inlet of the coalescing filter. Existing fuel systems, particularly for aircraft, include a water scavenging system. Water which condenses out of the fuel tends to run down the tank walls and collect, or pool, in one or more low points of the fuel tank. The water scavenging system typically includes an inlet at these low points and the system draws the pooled water through the inlet. The prior art scavenging system typically disperses this water back into the fuel in the fuel tank. However, the dispersed water will tend to condense and pool once more. In a preferred embodiment, the scavenging system outlet is connected to the filter inlet such that the water (more likely a water/fuel mixture) collected by the scavenging system is passed through the filter. This is advantageous since the filtrand is fed to the engine fuel feed system, which permanently removes the water from the fuel system. The water from the scavenging system may be entrained into the filter inlet flow. Water drain maintenance for the fuel tank is therefore significantly reduced or removed entirely.

To equalise pressures in the fuel system, a vent system may be used. When there is a net inflow of ambient air into the fuel system, water vapour may condense out onto cool surfaces. This water condensate would typically require water drain maintenance. In a preferred embodiment, the fuel system may further comprise a vent system for ventilating the fuel tank, wherein a water drain outlet of the vent system is connected to the inlet of the coalescing filter. The water from the vent system may be entrained into the filter inlet flow. This is advantageous since the filtrand is fed to the engine fuel feed system, which permanently removes the water from the fuel system. Water drain maintenance for the vent system is therefore significantly reduced or removed entirely.

### BRIEF DESCRIPTION OF THE DRAWINGS

Embodiments of the invention will now be described with reference to the accompanying drawings, in which:

FIG. 1 illustrates a section side view through a coalescing filter in accordance with a first embodiment;

FIG. 2 illustrates a section plan view through the coalescing filter;

FIG. 3 illustrates a block diagram of a fuel system including the coalescing filter;

FIG. 4 illustrates schematically a filter purge manifold arrangement for the coalescing filter;

FIG. 5 illustrates a coalescing filter in accordance with a second embodiment including a water drain outlet disposed in the filter inlet;

FIG. 6 illustrates a block diagram of a fuel system including the coalescing filter of FIG. 5; and

FIG. 7 illustrates a coalescing filter in accordance with a third embodiment including a reciprocating filter purge arrangement.

### DETAILED DESCRIPTION OF EMBODIMENT(S)

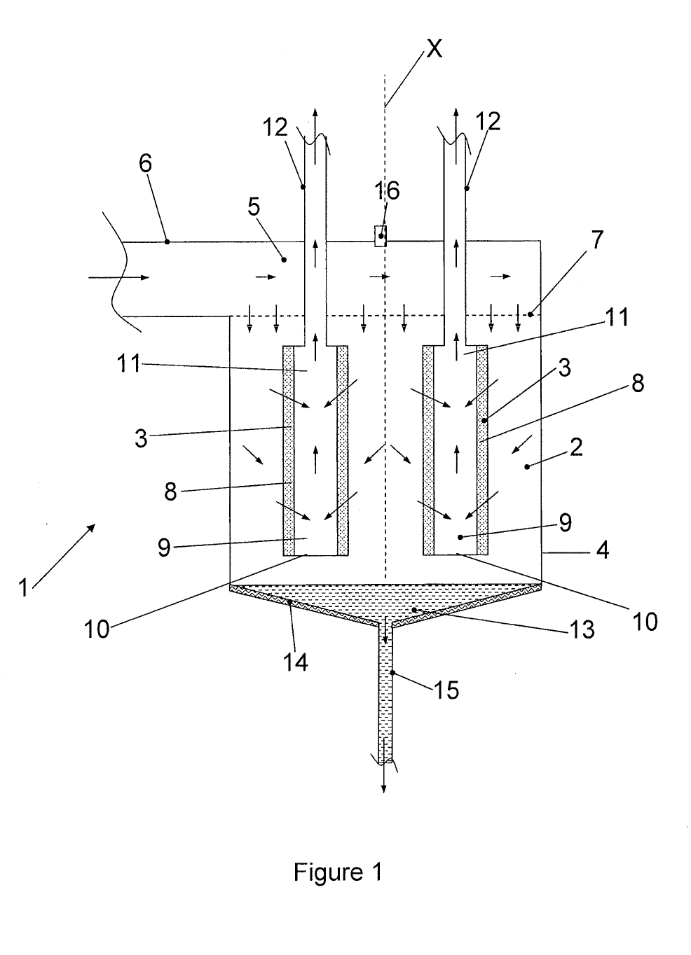

FIG. 1 illustrates a coalescing filter 1 comprising a filter chamber 2 containing four coalescing filter cartridges 3 (note that only two of the cartridges 3 are visible in the side section view of FIG. 1). The filter chamber 2 is defined by a substantially cylindrical outer housing 4 having a central longitudinal axis X. A plenum 5 is disposed above the filter chamber 2 and is concentric therewith. The plenum 5 has a tangential inlet 6. A perforated plate, or mesh 7 is disposed between the plenum 5 and the filter chamber 2. The filter cartridges 3 are each substantially cylindrical and include a flexible filter fabric 8 around a filter core 9. The filter cartridge 3 has a closed lower end 10 and an open upper end 11 in fluid communication with a second outlet 12. The second outlets 12 extend through an upper wall of the plenum 5. Beneath the filter chamber 2 is a sump 13 having a funnel shape. The lower surface of the sump 14 is heated. At the base of the funnel shaped sump 13 is a centrally located first outlet 15. An air release valve 16 is located in the upper wall of the plenum 5.

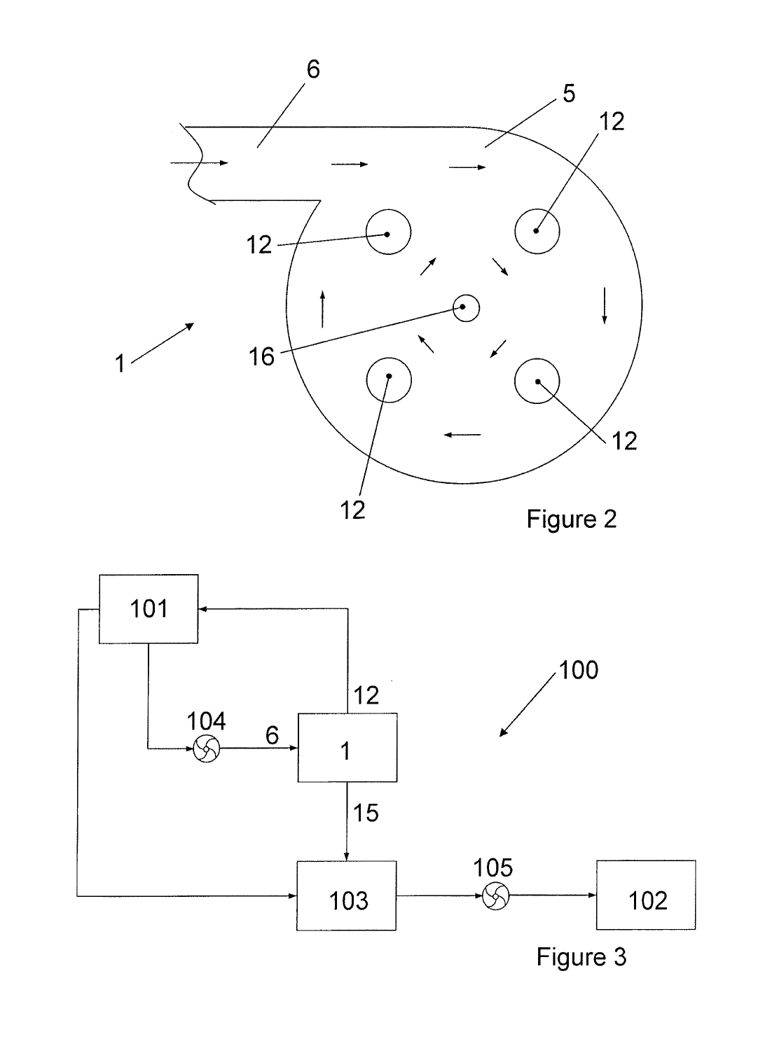

FIG. 2 illustrates a section plan view through the coalescing filter 1 and more clearly illustrates the tangential inlet 6 to the plenum 5, and how the four coalescing filters 3 are symmetrically arranged around the longitudinal central axis X of the filter chamber 2.

FIG. 3 illustrates a block diagram of a fuel system 100 including the coalescing filter 1. The fuel system 100 includes a liquid fuel tank 101, a combustion engine 102, the coalescing filter 1 and an engine feed inlet 103. The filter inlet 6 is fluidically connected to the fuel tank 101 and a pump 104 is arranged to deliver a supply of liquid fuel from the tank 101 to the filter inlet 6. The first filter outlet 15 is fluidically connected to the engine feed inlet 103 which is also connected to the fuel tank 101. An engine feed pump 105 is arranged to deliver a supply of fluid from the engine feed inlet 103 to the engine 102. The second filter outlet 12 is fluidically connected to the fuel tank 101.

Operation of the fuel system 100 will now be described with reference to FIGS. 1 to 3. The fuel tank 101 contains a supply of liquid fuel, which will naturally contain some water in suspension and may also contain some debris. When the fuel in the tank 101 is at a temperature near or below zero degrees Celsius the suspended water may turn to ice particles, which may remain suspended within the fuel. The pump 104 delivers a supply of fuel, with suspended water and/or ice particles, to the filter inlet 6. The pump 104 may be a jet pump fed by the main engine feed pump 105, or may be any other suitable pump.

Fuel with suspended water/ice particles entering the filter inlet 6 flows tangentially into the plenum 5 generating a swirl flow in the plenum 5. This flow is best represented in FIG. 2, where the arrow heads indicate the direction of fluid flow. The swirl flow finds its way to the filter chamber 2 below the plenum 5 through the perforated plate, or mesh, 7. The perforated plate 7 acts to distribute the flow to the chamber 2 evenly and to filter out some larger solid particulate debris. Although the filter 1 shown in FIGS. 1 and 2 has a four filter cartridge configuration, it will be appreciated that the filter may include any number of filter cartridges 3, including one. The air release valve 16 is installed to permit air trapped in the filter 1 to escape. The filter 1 is preferably installed within the fuel tank 101 and most preferably is sufficiently small as to be situated below the surface of the liquid fuel within the tank 101 under all normal operating conditions. However, the filter 1 may be disposed external to the fuel tank 101.

The flow from the plenum 5 to the chamber 2 below generates a general downward flow to encourage the settling of water droplets on the outer surface of the filter cartridges 3. Fuel flows from the chamber 2 through the coalescing filter fabric 8 into the filter core 9 of the operational filter cartridges 3. This flow is best represented in FIG. 1, where the arrow heads indicate the direction of fluid flow.

Each coalescing filter cartridge 3 separates suspended water droplets and/or ice particles and/or debris from the fuel leaving clean fuel filtrate flowing into the filter core 9. Water droplets are collected and coalesced to form larger droplets on the outer surface of the fabric 8 of the operational filter cartridges 3. Water then runs off from the fabric filter surface 8 under gravity falling through the space above the sump 13 into the sump beneath the chamber 2. This water will contain any ice particles and other debris of a size sufficiently large not to pass through the coalescing filter, such that the sump 13 collects water rich filtrand. The fuel filtrate flows from the filter core 9 through the second outlet 12 of each operational filter cartridge 3.

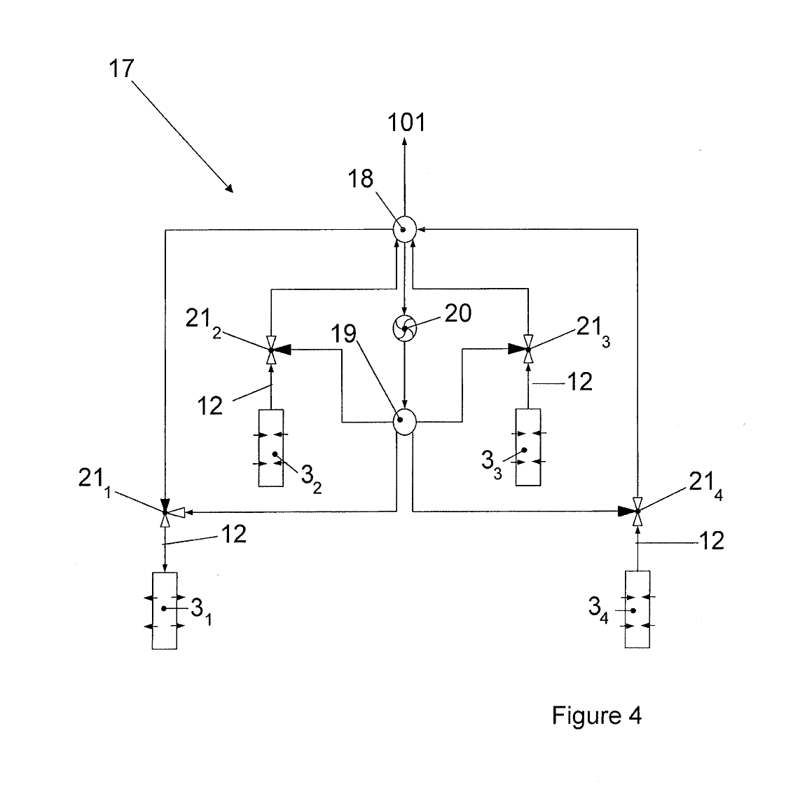

Water rich filtrand is drained off from the sump 13 through the first outlet 15 to the engine feed inlet 103 of an engine feed system. The engine feed system mixes the water rich filtrand with fuel from the tank 101 such that the concentration of water entrained into the fuel fed to the engine 102 by engine feed pump 105 is within acceptable limits set by the engine manufacturer. The filter 1 is adapted to perform a self purging operation for the filter cartridges 3. In this first embodiment, the filter 1 includes a manifold valve arrangement for reversing the direction of flow of the fuel filtrate through each of the filter cartridges 3 in turn during the purging operation. The manifold valve arrangement and the purging operation will now be described in detail with reference to FIG. 4.

FIG. 4 illustrates the manifold valve arrangement 17 for the filter 1. The manifold valve arrangement 17 includes a forward flow manifold 18, a return flow manifold 19, a pump 20 and a diverter valve 21 for each respective filter cartridge 3. The four filter cartridges are numbered 3₁, 3₂, 3₃, 3₄, and their corresponding diverter valves are numbered 21₁, 21₂, 21₃, and 21₄. The diverter valves 21 are two way diverter valves having three branches. The solid arrow approaching each diverter valve 21 indicates the closed branch of the diverter valve 21. Flow arrows have been used in FIG. 4 to indicate the direction of fluid flow through the manifold valve arrangement 17, and also to show the direction of fluid flow through each of the filter cartridges 3.

In FIG. 4, it can be seen that filter cartridges 3₂, 3₃ and 3₄ are operational so as to separate water from fuel, whilst filter cartridge 3₁ is being purged. The fuel filtrate being discharged through the filter core 9 of the filter cartridges 3₂, 3₃ and 3₄ is directed by their respective diverter valves 21₂, 21₃ and 21₄ to the forward flow manifold 18. The motive force driving the filter operation is provided by pump 104. Whilst the majority of the fuel filtrate arriving at the forward flow manifold 18 is returned to the fuel tank 101, a fraction of the fuel filtrate is extracted by pump 20 from the forward flow manifold 18 and is directed to the return flow manifold 19. Since the diverter valves 21₂, 21₃ and 21₄ each have a closed branch connected to the return flow manifold 19 there is no flow from the return flow manifold 19 to the diverter valves 21₂, 21₃ and 21₄. However, the branch of the diverter valve 21₁ which is connected to the return flow manifold 19 is open and so the pump 20 directs a flow of fuel filtrate from the return flow manifold 19 through the diverter valve 21₁ into the filter core 9 of the filter cartridge 3₁. This flow of fuel filtrate in the reverse direction through the filter cartridge 3₁ dislodges any water and/or ice and/or debris that may be clogged up on the outer surface of the filter fabric 8 of the filter 3₁. The dislodged water and/or ice and/or impurities falls into the sump 13 of the filter 1, leaving the filter cartridge 3₁ clean and purged of any obstruction.

At any one time, one of the four filters 3₁, 3₂, 3₃ and 3₄ is being regenerated (purged) whilst the other three filter cartridges are operational to separate water from fuel. This is achieved by opening and closing branches of the two way diverter valves 21. A sequence of operation of the manifold valve arrangement 17 will now be described for the filter 1.

Fuel from the active filter cartridges 3₂, 3₃ and 3₄ flows to the forward flow manifold 18. The flow is split into fuel filtrate outflow to the fuel tank 101 and return flow to the return flow manifold 19 in a ratio of (1−x):x. The return flow pump 20 runs continuously to deliver a constant return flow to the return flow manifold 19. With the diverter valve 21₁ in a return flow position as shown in FIG. 4 and the other diverter valves 21₂, 21₃ and 21₄ in a forward flow position, the return flow flows from the return flow manifold 19 to filter cartridge 3₁ whilst forward flow flows from filter cartridges 3₂, 3₃ and 3₄ to the forward flow manifold 18. In FIG. 4, filter cartridges 3₂, 3₃ and 3₄ are the active filters. They filter out suspended water droplets/ice particles/solid impurities in the fuel. Fuel from the filter chamber 2 flows to the filter cartridge cores 19 of the active filters 3₂, 3₃ and 3₄. Filter cartridge 3₁ is being regenerated with the return flow. Fuel from the filter core 9 of filter 3₁ flows out to the filter chamber 2. The reverse flow through the filter 3₁ sheds water/ice/impurity that may be clogged up on the filter surface off in to the filter chamber 2.

After some time t, diverter valve 21₁ is switched to the forward position, diverter valve 21₂ is switched to the return flow position, and the diverter valves 21₃ and 21₄ remain at the forward flow position. Filters 3₁, 3₃ and 3₄ become the active filters. Filter 3₂ is regenerated with the return flow. After some further time t, diverter valve 21₂ is switched to the forward flow position, diverter valve 21₃ is switched to the return flow position, and the remaining diverter valves 21₁ and 21₄ remain at the forward flow position. Filters 3₁, 3₂ and 3₄ become the active filters whilst filter 3₃ is regenerated with the return flow. After some further time t, diverter valve 21₃ is switched to the forward flow position, diverter valve 21₄ is switched to the return flow position, and the remaining diverter valves 21₁ and 21₂ remain at the forward flow position. Filters 3₁, 3₂ and 3₃ become the active filters whilst filter 3₄ is regenerated with the return flow. Finally, after some further time t, the cycle is repeated. The flow fraction x and the regeneration time t are predetermined to give the optimum filter operation.

The diverter valves 21₁, 21₂, 21₃ and 21₄ may be integrated in a manifold including the forward and return flow manifolds 18, 19 and the pump 20 for space saving.

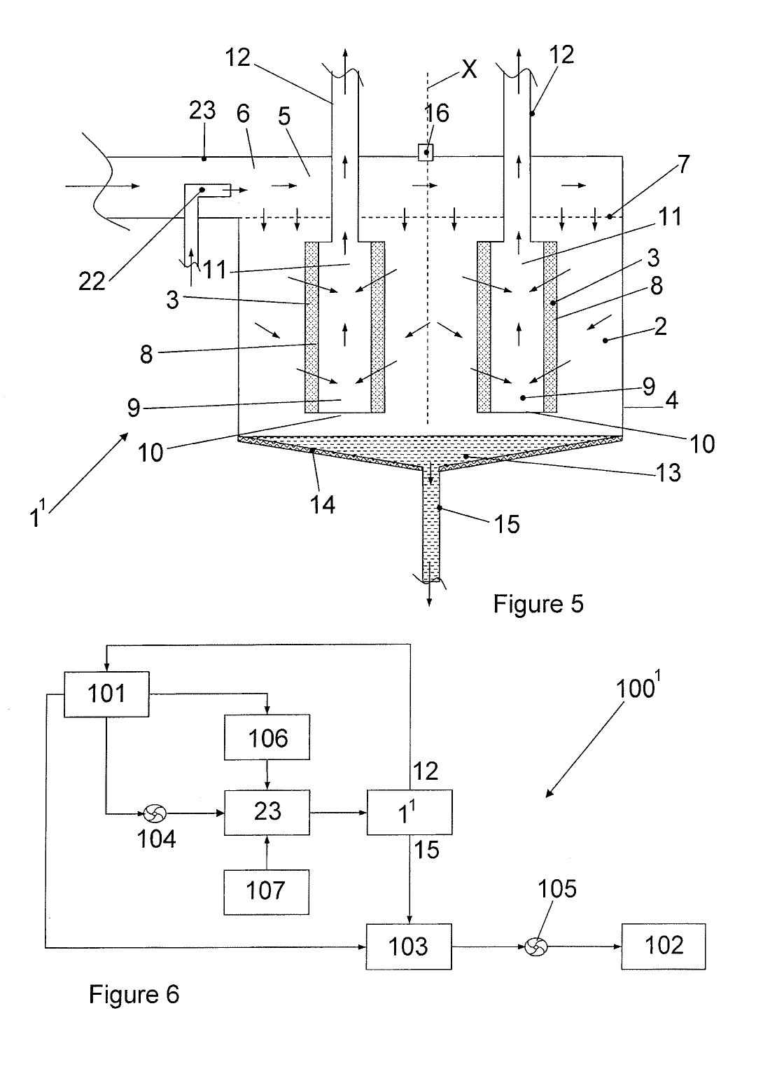

FIG. 5 illustrates a second embodiment of the filter 1¹ which shares many features in common with the filter 1 described above with reference to FIGS. 1 and 2. As such, like reference numerals have been used in FIG. 5 to denote like parts in FIG. 1 and only the differences between the filter 1¹ and the filter 1 will now be described.

The filter 1¹ includes a water drain outlet 22 which opens into an induction chamber 23 at the filter inlet 6. The water drain outlet 22 is connected to a water scavenge system and/or a water drain of a vent system. Water which condenses out of the fuel in the fuel tank 101 tends to run down the tank walls and collect, or pool in one or more low points of the fuel tank. The water scavenge system includes an inlet at these low points and the water scavenge system draws the pooled water through the inlet. The motive flow of fuel entering the filter inlet 6 induces a flow through the water scavenge system such that the scavenged water exits the water drain outlet 22 and becomes entrained with the motive flow of fuel at the induction chamber 23. In this way, a jet pump, which ordinarily would be required in a water scavenge system may be removed, as this may be unnecessary if the motive flow at the filter inlet 6 is sufficient to induce the flow in the water scavenge system.

Most fuel systems include a vent system for equalising pressures in the fuel system. When there is a net inflow of ambient air into the vent system, water vapour may condense out on to cool surfaces. This water condensate may be picked up and delivered to the filter inlet 6 by the induced water flow in the water drain outlet 22. All other operations of the filter 1¹ are identical to those of the filter 1 described previously.

FIG. 6 illustrates the filter 1¹ of the second embodiment installed in a fuel system 100¹ of the second embodiment. The fuel system 100¹ shares many features in common with the fuel system 100 described previously with reference to FIG. 3, and like reference numerals have been used to denote like parts for brevity. Only the differences between the fuel system 100¹ and the fuel system 100 will now be described.

The fuel system 100¹ includes a water scavenge system 106 for scavenging water from the sump of the fuel tank 101. The fuel system 100¹ further includes a vent system 107 for ventilating the fuel tank 101. The water scavenge system 106 and the vent system 107 each have a water drain outlet which is fluidically connected to the induction chamber 23.

Motive flow of fuel under action of pump 104 from the fuel tank 101 into the induction chamber 23 causes water to be entrained into the fuel flowing in the induction chamber which is then fed to the plenum 5 of the filter 1¹. The filter 1¹ discharges fuel filtrate from the second outlet 12 back to the fuel tank 101, and discharges water rich filtrand from the first outlet 15 to the engine feed system 103. The engine feed system 103 mixes the filtrand with fuel drawn from the fuel tank 101 under action of engine feed pump 105 before feeding the fuel and any entrained water to the combustion engine 102.

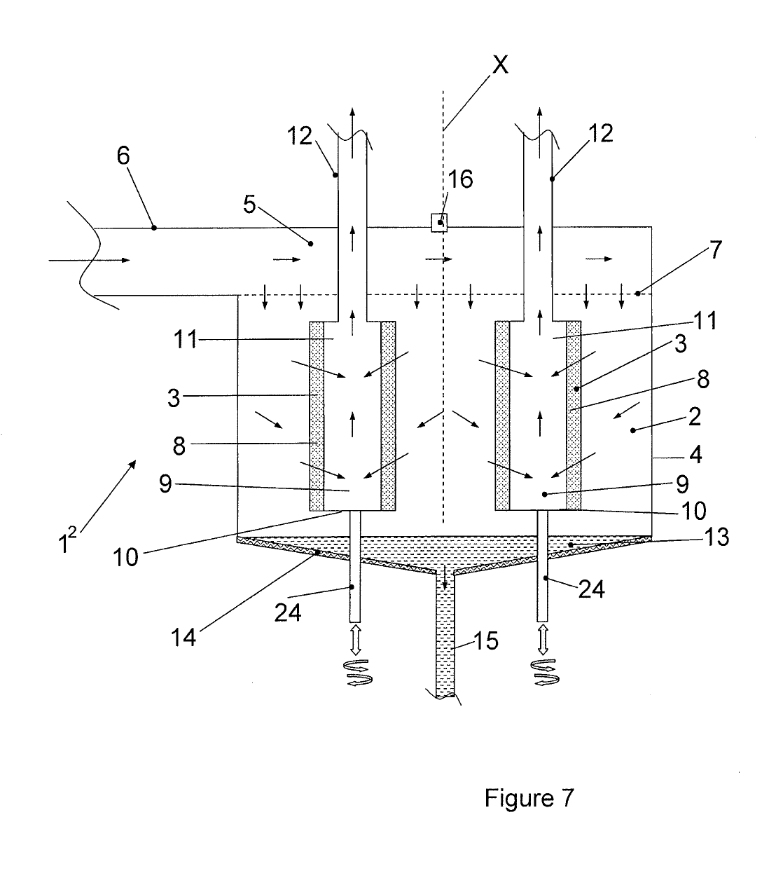

FIG. 7 illustrates a third embodiment of the coalescing filter 1² in accordance with a third embodiment. Like reference numerals have been used to denote like parts with the filter 1 of the first embodiment described above with reference to FIGS. 1 and 2. Only the differences between the filter 1² and the filter 1 will now be described.

The filter 1² does not have the manifold valve arrangement 17 described above with reference to FIG. 4. Instead, cyclical purging of the coalescing filter cartridges 3 is performed by a reciprocating plunger arrangement 24 to enhance water shedding and/or coalescing on the outer surface of the filter cartridge 3, and to prevent the filter surface from icing up at low temperatures. The flexible filter fabric 8 is mechanically flexed by the reciprocating plunger. The reciprocating plunger includes a push rod connected at the base of each filter cartridge 3 which performs a “push and twist” action. That is to say, the push rod rotates about its longitudinal axis as it translates in a direction along that axis. The motion of the push rod is provided by a crank arrangement (not shown in FIG. 7). A spring loaded collapsible frame (also not shown) retains the filter cartridge 3 in its desired cylindrical shape when the applied force on the push rod by the crank arrangement is removed. One of the four filter cartridges is purged by the reciprocating plunger at any one time, whilst the remaining three cartridges remain operational. The filter cartridges are purged one after the other in turn in a repeated purging cycle.

Whilst in the embodiments described above the filter includes a plurality of filter cartridges which are sequentially purged such that the filter performs a self purging operation whilst the filter remains operational, it will be appreciated that the self purging function is optional and also that the filter may include only a single coalescing filter cartridge. However, the provision of a plurality of filter cartridges makes it possible to purge the filter whilst the filter remains operational. It will be appreciated by those skilled in the art that the filter may alternatively be moved “off-line” to a non operational state such that a purging operation may be performed. In this case, the filter may include only a single filter cartridge. However, even when simultaneous operation and purging of the filter is not required it may still be beneficial that the filter includes a plurality of filter cartridges so as to increase the potential flow rate through the filter.

The fuel system may be installed in a vehicle, preferably an aircraft. In one embodiment, the coalescing filter is retro fit in an existing aircraft fuel system. The fuel tank is a lateral wing tank of the aircraft. Fuel from the main fuel pumps is delivered from the fuel tank to the coalescing filter. The fuel system includes a water scavenge system and a vent system, such as those described previously. Water from the vent system and from the water scavenge system is entrained into the fuel flow in the induction chamber of the coalescing filter. Fuel filtrate is discharged from the second outlet back into the fuel tank. Water rich filtrand is discharged from the first outlet to the engine fuel feed system. The filter is retrofit at the location previously occupied by two jet pumps; one for scavenging fuel and water from a vent surge tank of the vent system, and the other for scavenging water from the sump of the outer wing cell. Since the induction chamber of the filter induces the flow in the vent system and the water scavenge system these jet pumps can be removed which provides an overall weight saving despite the introduction of the filter. Some aircraft include an IDG oil cooler and the warm return flow pipe may be used to prevent freezing up of a water drain pipe connected to the first outlet of the filter, by disposing the water drain pipe in close proximity with the IDG return flow pipe. In other aircraft without such a convenient heat source, an alternative arrangement may be required to warm the water drain pipe to prevent icing, such as an electrically heated element around the pipe.

Although the invention has been described above with reference to one or more preferred embodiments, it will be appreciated that various changes or modifications may be made without departing from the scope of the invention as defined in the appended claims.

1. A fuel system comprising a liquid fuel tank, an engine, and a coalescing filter adapted to separate water from fuel, the filter having an inlet fluidically connected to the fuel tank, a first outlet fluidically connected to a fuel feed system for the engine, and a second outlet fluidically connected to the fuel tank, wherein the coalescing filter is adapted to discharge fuel filtrate from the second outlet and filtrand from the first outlet.

2. A fuel system according to claim 1, further comprising a fuel line connecting the fuel tank to the inlet of the coalescing filter, wherein the fuel line is connected to a fuel pump or forms part of a pressurised system for delivering fuel to the coalescing filter.

3. A fuel system according to claim 1, wherein the engine fuel feed system is adapted to mix fuel from the fuel tank with water-rich filtrand from the coalescing filter before supplying the mixture to the engine.

4. A fuel system according to claim 1, wherein the coalescing filter includes one or more filter cartridges disposed inside a filter chamber.

5. A fuel system according to claim 4, wherein the coalescing filter is adapted to perform a self-purging operation for the filter cartridge.

6. A fuel system according to claim 5, wherein the coalescing filter includes a valve arrangement for reversing the direction of flow of the fuel filtrate through the filter cartridge during the purging operation.

7. A fuel system according to claim 5, wherein the coalescing filter includes a reciprocating plunger for mechanically dislodging filtrand from the filter cartridge during the purging operation.

8. A fuel system according to claim 5, wherein the coalescing filter includes a plurality of the filter cartridges disposed inside the filter chamber, and is adapted to perform the self-purging operation by purging one or more of the plurality of filter cartridges, whilst at least one of the other filter cartridges remains operational.

9. A fuel system according to claim 8, the coalescing filter is adapted to perform the self-purging operation by purging each filter cartridge in turn, whilst the other filter cartridges remain operational.

10. A fuel system according to claim 4, wherein the coalescing filter includes a sump disposed beneath the filter chamber for collecting the filtrand.

11. A fuel system according to claim 10, wherein the sump includes a heating element.

12. A fuel system according to claim 1, further comprising a water scavenging system for scavenging water from the fuel tank, wherein a water drain outlet of the water scavenging system is connected to the inlet of the coalescing filter.

13. A fuel system according to claim 1, further comprising a vent system for ventilating the fuel tank, wherein a water drain outlet of the vent system is connected to the inlet of the coalescing filter.

14. A vehicle, preferably an aircraft, including the fuel system of claim 1.

15. A method of removing water or ice from a fuel tank, the method comprising directing a flow of fuel from a fuel tank to a coalescing filter adapted to separate water from fuel, discharging filtrand from a first outlet of the coalescing filter to a fuel feed system for consumption by an engine, and discharging fuel filtrate from a second outlet of the coalescing filter and returning the fuel filtrate to the fuel tank.

16. A method according to claim 15, further comprising mixing fuel from the fuel tank with water-rich filtrand from the coalescing filter using the engine fuel feed system before supplying the mixture to the engine.

17. A method according to claim 15, further comprising performing a self-purging operation on the coalescing filter.

18. A method according to claim 15, further comprising entraining one or more
sources of water into the flow of fuel entering the coalescing filter.
